(19) United States
(12) Patent Application Publication
(10) Pub. No.: US 2012/0294114 A1
(43) Pub. Date: Nov. 22, 2012

(54) ACOUSTIC TELEMETRY OF SUBSEA MEASUREMENTS FROM AN OFFSHORE WELL

(75) Inventors: Matt Gochnour, Houston, TX (US); Adam Dudley Lawrence Hudson, Houston, TX (US); Roland Peter Sauermann, Houston, TX (US); Jonathan Peter Davis, Cypress, TX (US); Douglas Graham Wood, Aberdeenshire (GB); Christopher John Curran, Houston, TX (US)

(73) Assignees: BP EXPLORATION OPERATING COMPANY LIMITED, Sunbury-On-Thames (GB); BP CORPORATION NORTH AMERICA INC., Houston, TX (US)

(21) Appl. No.: 13/452,185

(22) Filed: Apr. 20, 2012

Related U.S. Application Data
(60) Provisional application No. 61/479,240, filed on Apr. 26, 2011.

(51) Int. Cl. G10K 11/00; H04B 17/00; E21B 43/01

(52) U.S. Cl. 367/13; 166/336; 367/141

(57) ABSTRACT

Sensor and communications systems are disclosed for communicating measurements from subsea equipment, such as at an offshore well, to the surface. A sensor for a physical parameter, such as pressure or temperature at a blowout preventer, capping stack, or conduit in communication with the same, is electrically connected to a subsea acoustic transponder. An acoustic communications device, for example an acoustic transducer and transceiver electronics deployed on a remotely-operated vehicle, interrogates the acoustic transponder with an acoustic signal, in response to which the acoustic transponder transmits an acoustic signal encoded with the measurement. The acquired measurement data are then communicated to a redundant network at the surface. The sensor and acoustic transponder systems can be installed after an event at the subsea equipment, such as blowout of the well.

### CROSS-REFERENCE TO RELATED APPLICATIONS

This application claims the benefit of U.S. Provisional Application No. 61/479,240 filed Apr. 26, 2011.

This application is related to copending and commonly assigned Attorney Docket No. 40099, entitled “Acoustic Transponder for Monitoring Subsea Measurements from an Offshore Well”, filed contemporaneously herewith and incorporated herein by reference.

### STATEMENT REGARDING FEDERALLY SPONSORED RESEARCH OR DEVELOPMENT

Not applicable.

### BACKGROUND

This invention is in the field of oil and gas production. Embodiments of this invention are directed to the monitoring and communication of measurements, such as pressures, from deep subsea equipment, such as blowout preventers and capping stacks installed at offshore oil and gas wells.

As known in the art, the penetration of high-pressure reservoirs and formations during the drilling of an oil and gas well can cause a sudden pressure increase (“kick”) in the wellbore itself. A significantly large pressure kick can result in a “blowout” of drill pipe, casing, drilling mud, and hydrocarbons from the wellbore.

Blowout preventers (“BOPs”) are commonly used in the drilling and completion of oil and gas wells to protect drilling and operational personnel, and the well site and its equipment, from the effects of a blowout. In a general sense, a blowout preventer is a remotely controlled valve or set of valves that can close off the wellbore in the event of an unanticipated increase in well pressure. Modern blowout preventers typically include several valves, or “rams”, arranged in a “stack” surrounding the drill string. The valves within a given stack typically differ from one another in their manner of operation, and in their pressure rating, thus providing varying degrees of well control, including sealing of the well annulus at various pressures. Many BOPs include a valve of a “blind shear ram” type, which can sever the drill string and seal the wellbore, serving as potential protection against a blowout. As known in the art, the individual valves in blowout preventers are hydraulically actuated in response to initiation by electrical signals; other techniques for activating the blowout preventer include an “Autoshear” approach in which the valves are activated automatically in the event of an unplanned LMRP disconnect, and a “deadman” automatic mode in which the valves are activated in the event that the control systems lose their communication, electrical power, and hydraulic functions. In addition, some modern blowout preventers can be actuated by remote operated vehicles (ROVs), should the internal electrical and hydraulic control systems become inoperable. Typically, some level of redundancy for the control systems in modern blowout preventers is provided.

To carry out monitoring and analysis, measurements are obtained from the blowout preventer during periodic testing, and also by monitoring certain parameters during drilling and well completion. Especially in deep sub-sea environments, sensors for measuring downhole pressure and other parameters are now conventionally deployed in the “Christmas tree” at the seafloor, and in the blowout preventer. In addition, during the drilling operation, measurements regarding the drilling operation can be acquired (measurement-while-drilling, or “MWD”) downhole, as can measurements regarding the surrounding formation into which the drilling is being performed (logging-while-drilling, or “LWD”). During production, sensors in the production tubing at the seafloor or below are often deployed to make electrical measurements from which monitoring can be carried out.

These and other measurements are communicated in some manner to the surface, for analysis by the appropriate systems and personnel. Various conventional communication techniques utilize the drill pipe or production tubing as the communications medium. For example, wired drill pipe and production tubing is now commonplace, with signals transmitted from the seafloor or even downhole along wire or optical fibers running the length of the drill pipe or tubing to the surface. These wired or fiber optic communications approaches are available for communication of pressure measurements from the blowout preventer. Other telemetry approaches useful in the drilling context include mud pulse telemetry within the drill string, and electromagnetic telemetry (EM tools).

In each of these cases, however, communication of pressure measurements from the seafloor or below utilize an intact physical communications conduit between the subsurface sensors and surface vessels, in the offshore production context. Given the environment often encountered in offshore production, as well as the long distances between surface and seafloor in modern deep offshore production, the communication conduit can become corrupted or discontinuous. For example, the wire or optical fibers in “wired” production tubing can corrode, break, or otherwise lose good transmission capability.

In cases, the drill string or production tubing may itself become broken or cut, for example in the case of a blowout of the well and subsequent severing of the riser from the blowout preventer, thus severing the communications facility between the seafloor and the surface. In these events, the monitoring of pressures at the blowout preventer, or at a subsequently deployed capping stack placed over the blown-out well, becomes beneficial in managing the failed well. These pressure measurements may provide an indication of the ability of the blowout preventer or capping stack to control the well, and also indicate whether the well casing and rupture disks are intact and maintaining integrity. In addition, pressure measurements at production equipment, such as the choke and kill lines at the blowout preventer, allow monitoring of remediation efforts involved in shutting-in the well after the blowout preventer rams have been activated.

By way of further background, the use of remote operated vehicles (ROVs) is now commonplace in offshore drilling and production. Navigation of a subsea ROV requires knowledge of its position relative to the subsea installations. As is known in the art, the dynamic positioning of ROVs can be accomplished by acoustic signaling between the ROV and multiple fixed transponders. The fixed transponders, for example computerized acoustic telemetry transponders (“Compatts”) such as those available from Sonardyne, Inc., include acoustic transceivers for communication with ROVs and surface vessels. According to one conventional positioning approach, the ROV issues an acoustic interrogation signal to a transponder (e.g., a Compatt) deployed at a known location, in response to which the transponder issues an acoustic signal. The response signal may be a simple tone at a frequency particular to the specific transponder, or may be a modulated wideband signal (such as a phase-shift keyed, or PSK, modulated signal) such as the wideband technology used by the Sonardyne Compatts. In one approach, for example as used by the Sonardyne Compatts, the modulated response signal from the transponder includes information indicating the location of the transponder as deployed. Based on the location information and the travel time of the response signal (e.g., the round-trip travel time of the interrogation signal plus the response) from multiple fixed-location transponders, the location of the ROV can be calculated using triangulation or trilateralization (in which the location information of the transponder is used in combination with the signal travel time).

By way of further background, certain transponders, such as the COMPATT5 and COMPATT6 acoustic transponders from Sonardyne, Inc., are capable of carrying out data telemetry. These transponders can be deployed with optional sensors, such as inclinometers, pressure sensors, and strain gauges, and include a modem function to acoustically communicate measurement data acquired from those sensors.

### BRIEF SUMMARY

Embodiments of this invention include a communications system and method of operating the same by way of which pressure measurements and the like at equipment near at the seafloor can be communicated to surface vessels in situations in which the normal communications facility has been severed or otherwise corrupted.

Embodiments of this invention include such a system and method in which a high degree of system redundancy, and thus measurement reliability, is attained.

Embodiments of this invention include such a system and method that is suitable for use in connection with events in deep subsea environments.

Embodiments of this invention include such a system and method that can be readily deployed into the blowout preventer after its activation and the resulting shearing of the drill string or production tubing.

Embodiments of this invention include such a system and method that is compatible with various coupling mechanisms at seafloor installations.

Embodiments of this invention include such a system and method suitable for use in connection with both blowout preventers and capping stacks.

This invention may be implemented into a sensor and acoustic transponder arrangement that can be installed at appropriate locations of a sealing element assembly, such as a blowout preventer or capping stack, after the severing of the riser and drill string, or production tubing, as the case may be. The sensor is installed by way of a flange, or hot stab, to be in fluid communication with the desired location of the well or subsea equipment, with the sensor output in electrical communication with an acoustic transponder. The acoustic transponder is capable of responding to an acoustic interrogation signal, such as from a remotely operated vehicle (ROV), and transmitting an acoustic signal encoded with the sensor measurement. The ROV communicates the measurement data to terminal servers aboard ship, and ultimately to an onshore data center.

According to another aspect of the invention, communications redundancy is implemented from the vicinity of the well to the various data centers. Surface vessels in the vicinity of the well are networked among themselves, allowing for communication of the measurement data in network at the vicinity of the well; satellite communications are used to redundantly communicate the measurement data to multiple onshore data centers.

According to another aspect of the invention, post-installation calibration of measurement values is performed, based on calculation of the resistance that converts analog sensor output currents into analog voltages. A sensor measurement is obtained from an installed subsea sensor, under ambient conditions at which an independent knowledge of the ambient pressure (for example) has been obtained. Manufacturer calibration data for the specific sensor is then used to estimate the current at the known ambient pressure (or other parameter value), and the converted voltage is divided by that estimated current to obtain the precise resistance value of the resistor in the sensor loop. Measured voltages can be divided by that resistance value to obtain sensor output current values, and thus accurate measurements of the physical parameter being sensed.

### BRIEF DESCRIPTION OF THE SEVERAL VIEWS OF THE DRAWINGS

FIG. 1 is an elevation view illustrating the arrangement of a conventional offshore oil and gas well at the time of drilling.

FIG. 2 is an elevation view of a blowout preventer including its lower marine riser package (LMRP), such as used in the arrangement of FIG. 1.

FIG. 3 is an elevation view illustrating an offshore well after a blowout event, and including measurement and communications systems according to embodiments of the invention.

FIG. 4 is a flow diagram illustrating the generalized operation of embodiments of the invention.

FIGS. 5a through 5e are elevation, perspective, and schematic views of a sensor and transponder arrangement according to an embodiment of the invention.

FIGS. 6a through 6e are elevation, perspective, and schematic views of a sensor and transponder arrangement according to another embodiment of the invention.

FIG. 7a is an elevation view illustrating the redundant acquisition and communication of measurement data according to an embodiment of the invention.

FIG. 7b is a data flow diagram illustrating the operation of a redundant acquisition and communication of measurement data according to that embodiment of the invention.

### DETAILED DESCRIPTION

This invention will be described in connection with certain embodiments, specifically as implemented in connection with a blowout preventer, and other subsea equipment such as a capping stack, associated with a deepwater offshore oil well, as it is contemplated that this invention is especially beneficial when implemented in such an application. However, it is contemplated that this invention will be beneficial if applied to other types of equipment in similar environments. Accordingly, it is to be understood that the following description is provided by way of example only, and is not intended to limit the true scope of this invention as claimed.

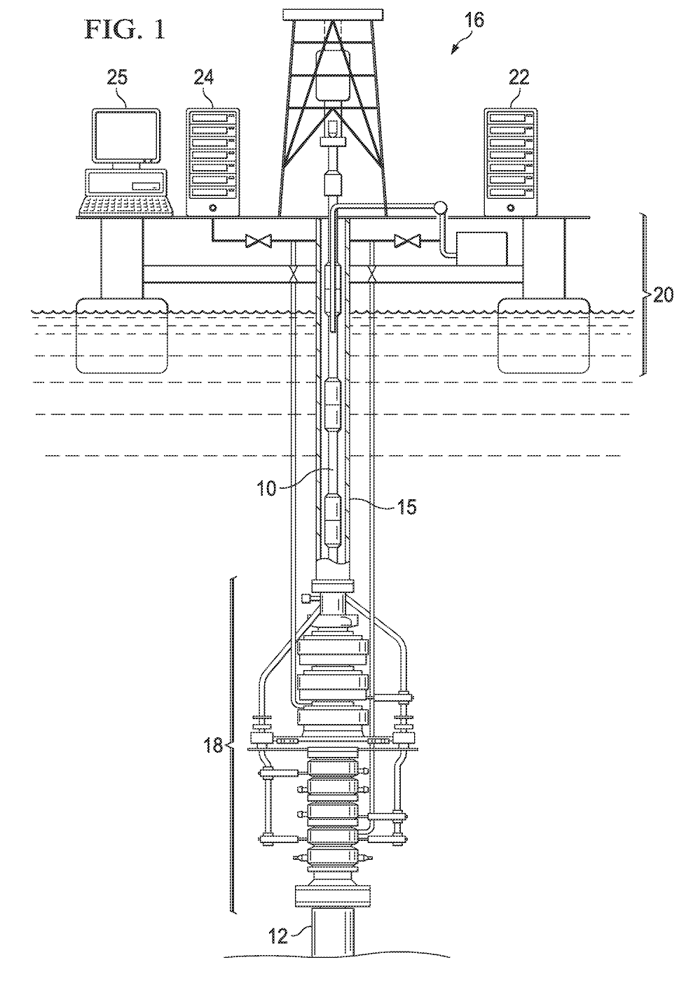

FIG. 1 illustrates a generalized example of the basic conventional components involved in drilling an oil and gas well in an offshore environment, to provide context for this description. In this example, drilling rig 16 is supported at offshore platform 20, and is supporting and driving drill pipe 10 within riser 15, in the conventional manner. Blowout preventer (or BOP) 18 includes the “stack” of sealing rams, and is attached to and supported from wellhead 12, which itself is located at or near the seafloor. Riser 15 is attached to blowout preventer 18 by way of a lower marine riser package, or “LMRP”, which is connected to the bottom of riser 15. Drill pipe 10 passes through riser 15 and blowout preventer 18, and extends into the seafloor to the depth at which drilling is currently taking place.

Offshore drilling operations are carried out by way of computer monitoring and control systems. In this regard, drilling control computer 22 is provided at drilling rig 16, to control various drilling functions, including the drilling operation itself and the circulation and control of the drilling mud. Blowout preventer control computer 24 is a computer system that controls the operation of blowout preventer 18. Each of computer resources 22, 24, receives various inputs from downhole sensors along the wellbore, including from sensors deployed within blowout preventer 18. While each of drilling control computer 22 and BOP control computer 24 are deployed at offshore platform 20, in this example, these computer systems are in communication with onshore servers and computing resources by way of radio or satellite communications.

As evident from this description, FIG. 1 illustrates drilling rig 16 in the context of the drilling operations. Once drilling of the well to the desired depth is accomplished, various well completion operations will be performed. In completing the well, blowout preventer 18 will be removed from wellhead 12 in favor of a control valve tree including production valves and safety control valves. Production from the well will be conducted to subsea manifolds via production tubing, as controlled by the Christmas tree, eventually routing the produced oil and gas to an offshore production facility or subsea flowline, as the case may be.

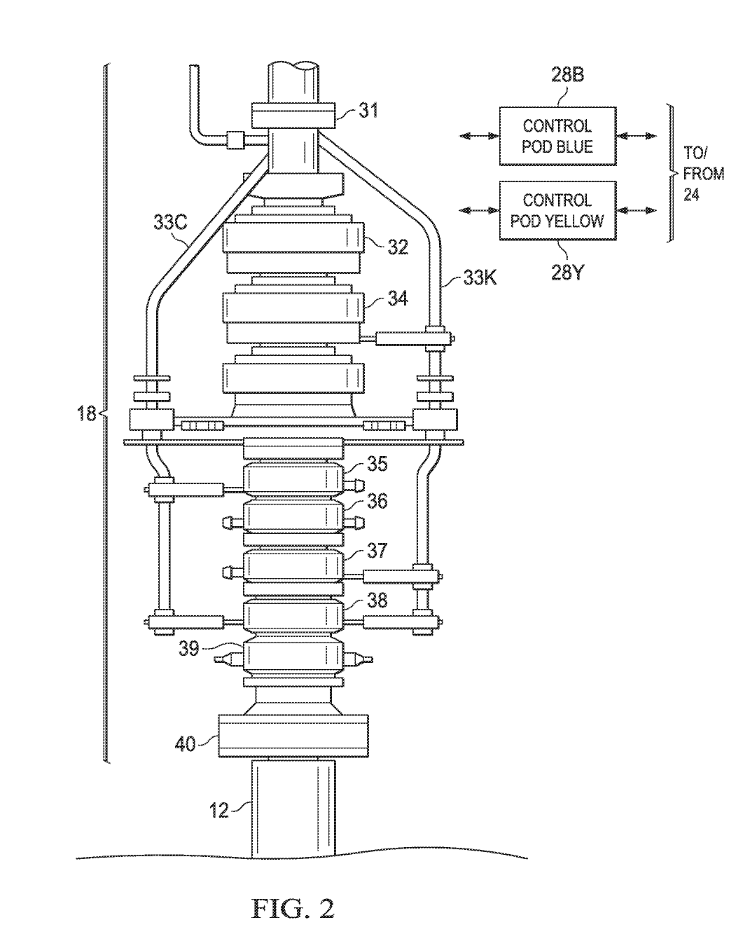

An example of blowout preventer 18 including its LMRP is shown in greater detail in FIG. 2. Blowout preventer 18 can include multiple types of sealing elements, with the various elements typically having different pressure ratings, and often performing their sealing function in different ways from one another. Such redundancy in the sealing elements not only supports reliable operation of blowout preventer 18 in preventing failure during a high pressure event, but also provides responsive well control functionality during non-emergency operation. Of course, the number and types of sealing members within a given blowout preventer will vary from installation to installation, and from environment to environment. As such, the construction of blowout preventer 18 of FIG. 2 is presented in this specification by way of example only, to provide context for the embodiments of the invention described herein.

In this example, as shown in FIG. 2, blowout preventer 18 includes riser connector 31, which connects blowout preventer 18 to riser 15 (FIG. 1); on its opposite end, blowout preventer 18 is connected to wellhead 12 by way of wellhead connector 40. From top to bottom, the sealing elements of this example of blowout preventer 18 include upper annular element 32, lower annular element 34 (the annular elements 32, 34 typically considered as part of the LMRP), blind shear ram element 35, casing shear ram element 36, upper ram element 37, lower ram element 38, and test ram element 39. To summarize, annular elements 34, 35, when actuated, operate as bladder seals against drill pipe 10, and because of their bladder-style construction are useful with drill pipe 10 of varying outside diameter and cross-sectional shape. Ram elements 37, 38, 39 include rubber or rubber-like sealing members of a given shape that press against drill pipe 10 to perform the sealing function. When actuated, shear ram elements 35, 36 operate to shear drill pipe 10 and casing, respectively; blind shear ram element 35 is intended to also seal the wellbore. As mentioned above, these various elements typically have different pressure ratings, and thus provide a wide range of well control functions.

Control pods 28B, 28Y are also shown schematically in FIG. 2. Each of control pods 28B, 28Y include the appropriate electronic and hydraulic control systems, by way of which the various sealing elements are controllably actuated and their positions sensed. Control pods 28B, 28Y are deployed in the lower marine riser package connected to the bottom of riser 15, and include redundant control channels for operation of the hydraulic control valves involved in the actuation of the various sealing elements as desired. Blue control pod 28B and yellow control pod 28Y are constructed essentially as duplicates of one another, each capable of actuating each of the elements of blowout preventer 18. In addition, BOP control computer 24 includes monitoring and diagnostic capability by way of which the functionality of control pods 28B, 28Y are analyzed, based on communication between control pods 28B, 28Y and control computer 24. The communications medium between downhole and the surface can be wired drill pipe, fiber optics along the drill pipe or tubing, and the like.

For purposes of the description of embodiments of this invention, FIG. 2 illustrates kill line 33K and choke line 33C at blowout preventer 18. Kill line 33K is a high-pressure pipe connected between an outlet at blowout preventer 18 and rig pumps at drilling rig 16. Choke line 33C is a high-pressure pipe connected between an outlet at blowout preventer 18 and a backpressure choke and associated manifold (not shown). Choke line 33C and kill line 33K exit the subsea blowout preventer 18, and run along the outside of riser 15 to the surface.

During well control operations, upon actuating the appropriate rams of blowout preventer 18, kill fluid is pumped through the drillstring into the wellbore, circulating back to wellhead 12 via the annulus, and out of the well through choke line 33C to the backpressure choke, which is controlled to reduce the fluid pressure to atmospheric. In those cases in which circulation through the drill string is not possible, drilling mud is pumped from the surface into kill line 33K (and also possibly via choke line 33C in redundant fashion); this approach is known in the art as “bullheading”. In the event of a blowout event in which riser 15 is severed from the top of blowout preventer 18, it is known to control the well by severing one or both of kill line 33K and choke line 33C from riser 15, and connect these lines 33K, 33C, via a jumper line, to a source of drilling mud at the surface, or to a downhole collection and disposal manifold, or to an alternative source or destination for the fluid. With this connection, heavy drilling mud can be routed through the jumpers into either or both of choke line 33K and kill line 33C into the well via blowout preventer 18, to regain control of the well.

General Construction and Operation of the Sensor Communication System

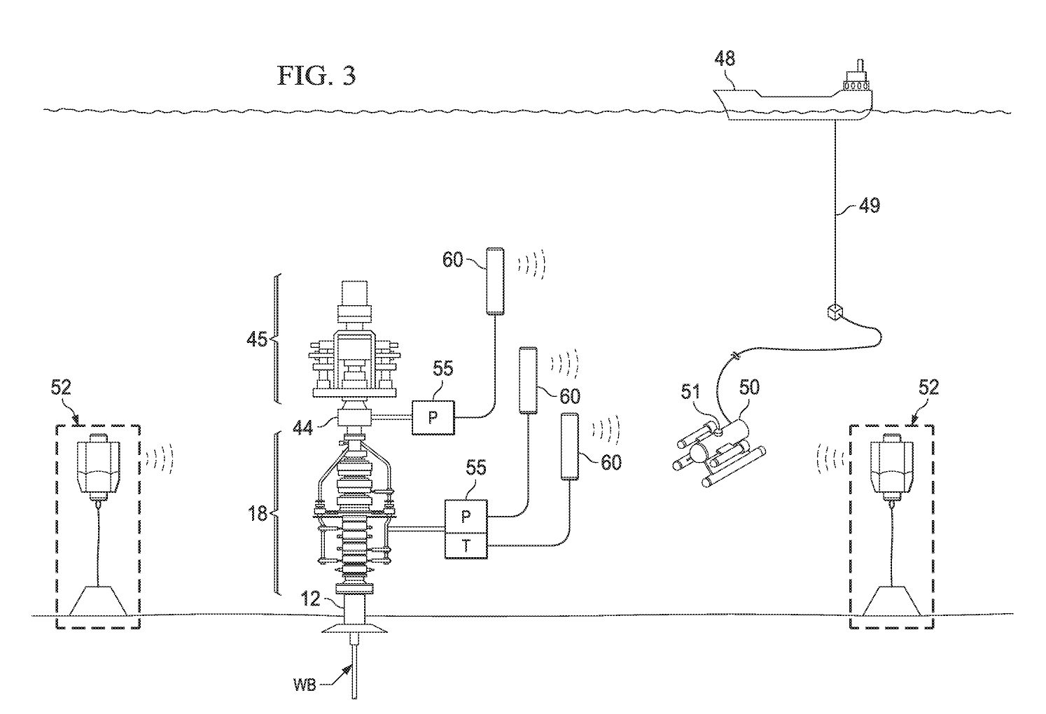

FIG. 3 illustrates a subsea situation in which a blowout has severed riser 15 and drill string 10 from blowout preventer 18, and in which additional equipment has been installed to gain control of the well. In the example of FIG. 3, capping stack 45 is placed upon and connected to lower marine riser package 44 at the top of blowout preventer 18. Capping stack 45 includes one or more sealing elements, such as blind or shear rams similar to those in blowout preventer 18 itself. Also in this example, some operations in the installation of capping stack 45, as well as control and monitoring of the operation of capping stack 45 and blowout preventer 18 are carried out by way of remotely-operated vehicle (ROV) 50. In the conventional manner, ROV 50 itself is navigated and controlled from ship 48 at the surface, via umbilical 49. In order to navigate ROV 50, knowledge of the location of ROV 50 relative to the subsea equipment of blowout preventer 18 and capping stack 45 is required. In the conventional manner, acoustic communications are carried out between an acoustic transceiver (not shown) deployed on ROV 50, and multiple fixed acoustic transponders 52 anchored to the seafloor as shown. For example, the acoustic transceiver (not shown) implemented on ROV 50, according to embodiments of the invention, may be a conventional configurable, tri-band acoustic transceiver such as the COMPATT 5 transceiver available from Sonardyne, Inc. Conventional electronic functionality is provided within ROV 50 to demodulate and decode the received acoustic signals, and to transmit signals corresponding to those received signals via cabling within umbilical 49 to its ship 48, at which computer functionality is deployed to analyze the signals received by ROV 50, and to control its navigation. As discussed above in connection with the Background of the Invention, the round-trip travel times of an acoustic interrogation signal from ROV 50 to each of multiple transponders 52 plus the acoustic response signals from those transponders 52 and ROV 50, can be applied to a triangulation or trilateralization technique to resolve the current three-dimensional position of ROV 50.

In a blowout situation such as that illustrated in FIG. 3, surface personnel will need to understand the status of the well. As known in the art, parameters of particular importance include pressures and temperatures in the wellbore, and at equipment such as blowout preventer 18 including its LMRP, and capping stack 45 in FIG. 3. For example, if kill line 33K and choke line 33C have been re-routed to conduct kill fluid or drilling mud, pressures and temperatures sensed at kill line 33K and choke line 33C will be indicative of well pressure and temperature, and will thus provide important knowledge regarding the extent to which the well is being controlled. However, because riser 15 and the associated tubing have been severed from blowout preventer 18, the usual communications medium between pressure and temperature sensors at blowout preventer 18 and monitoring systems at the surface is lost. Even if those downhole pressure and temperature sensors are operable, their readings cannot be monitored with any sort of regularity, much less in the real-time manner that is demanded in responding to such an event.

In the generalized arrangement of FIG. 3, according to embodiments of this invention, communications capability is configured to communicate subsea pressure and temperature sensors, obtained at sealing elements and conduits of blowout preventer 18 and (if installed and operable) capping stack 45, to surface personnel for monitoring, analysis, and decisions regarding additional control efforts. As shown in FIG. 3, one or more sensors 55 are deployed at blowout preventer 18 and at capping stack 45 (e.g., at connector 44 between capping stack 45 and blowout preventer 18). Each deployment of sensors 55 includes one or more sensors in fluid communication with the wellbore itself via blowout preventer 18 or capping stack 45, as the case may be, or in fluid communication with fluids such as kill fluid or drilling mud being used to control the well. It is contemplated that sensors 55 will include one or more instances of either or both of pressure and temperature sensors, as it is contemplated that these measurements assist personnel charged with controlling the well in this situation. In this example, sensors 55 at blowout preventer 18 include the combination of a pressure sensor (P) and a temperature sensor (T). Of course, sensors 55 can include sensors for other attributes and parameters, as desired. In embodiments of this invention, each sensor 55 generates an electrical signal as an output, indicative of the sensed physical parameter.

According to embodiments of this invention, the measurements obtained by sensors 55 are communicated to the surface. As such, the output signal from each sensor 55 is electrically coupled to a corresponding acoustic transponder 60. In the example of FIG. 3, each of the pressure and temperature sensors 55 at blowout preventer 18 is coupled to its own acoustic transponder 60, as shown. Acoustic transponders 60 are conventional computerized acoustic telemetry transponders (“compatts”), such as the COMPATT 5 and COMPATT 6 transponders available from Sonardyne, Inc. Each transponder 60 receives an output electrical signal from its associated sensor 55, and upon interrogation by an acoustic signal received from an acoustic communications device, transmits an acoustic signal encoded with data representative of the pressure, temperature, or other parameter sensed by sensor 55. This acoustic communications device is capable of compatible acoustic communication with the particular model transponder deployed as transponders 60. In the example of FIG. 3, such an acoustic communications device is realized in the conventional manner for ROV navigation by acoustic transducer 51 mounted at ROV 50, in combination with transceiver electronics (not shown) within a separate housing at ROV 50. Multiple ROVs 50 may be in the vicinity of the well, each gathering measurement data from the various sensors 55 via transponders 60, as will be described below.

Underwater acoustic communications between ROV 50 and transponders 52 for purposes of ROV navigation can be tone-based, with each transponder 52 issuing a response signal at an assigned frequency with no modulation. However, underwater communication of actual measurement data necessitates a more complex protocol than a simple tone at a given frequency. In embodiments of this invention, each transponder 60 transmits an acoustic signal that is modulated with the measurement data from its sensor 55. In a subsea environment in which acoustic transducer 51 at ROV 50 (including, as described below, each of multiple ROVs 50 in the vicinity) is acoustically receiving measurement data from each of multiple transponders 60 for each of multiple associated sensors 55, data-bearing communications from each transponder 60 must be communicated in a dedicated channel to avoid interference. According to embodiments of this invention, such communication of measurement data by transponders 60 to acoustic transducers 51 at corresponding ROVs 50 can be accomplished via wideband acoustic transmission as now supported by modern acoustic transponders, such as the COMPATT 5 and COMPATT 6 transponders available from Sonardyne, Inc., for example. Also as described above, acoustic transducer 51 at ROV 50 may be the same acoustic transducer that, in combination with its transceiver electronics, is used in the navigation of ROV 50. Alternatively, a dedicated acoustic transducer or transceiver electronics, or both, may be used, if desired.

According to embodiments of the invention following the Sonardyne approach, each transponder 60 is assigned a dedicated transponder address code, to be used in generating a response to an interrogation signal received at a particular interrogation frequency. In this wideband implementation, the interrogation signals may also be wideband signals, with ROVs 50 controlled from different surface vessels having different assigned interrogation address codes relative to one another; typically, the interrogation carrier frequency differs from the response carrier frequency.

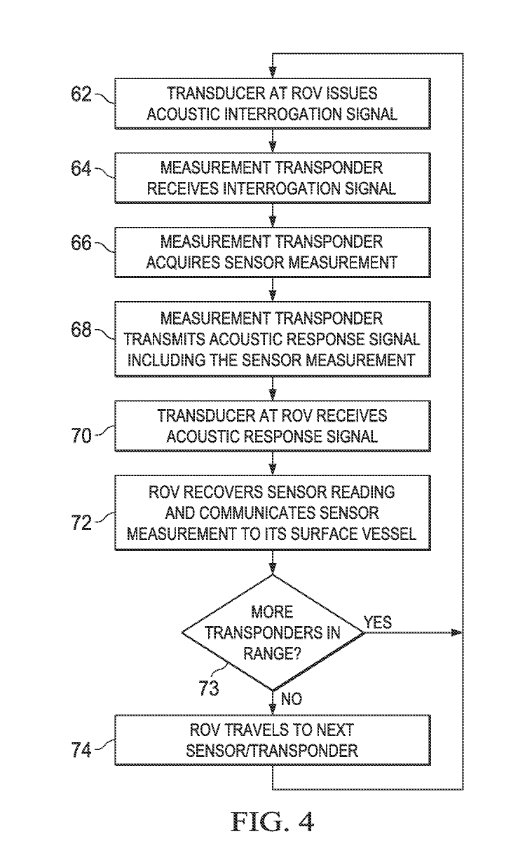

FIG. 4 illustrates a generalized interrogation procedure by way of which measurements by sensors 55 are communicated to ship 48 according to embodiments of the invention. It is of course contemplated that variations and alternatives to this method of communications will be apparent to those skilled in the art having reference to this specification.

The operation of this procedure begins with process 62, in which acoustic transducer 51 at ROV 50 issues an acoustic interrogation signal to a selected one of transponders 60, to initiate acquisition of measurement data from its associated sensor 55. As mentioned above, in the wideband acoustic context, this interrogation signal may be a wideband signal at a preselected acoustic carrier frequency, encoded according to the address code associated with ROV 50, and selectively including an interrogation message addressed specifically to the selected one of transponders 60 from which a response is desired. In process 64, transponder 60 receives this interrogation signal, and recognizes it as such. In response to the received interrogation signal, transponder 60 acquires one or more quanta of measurement data from its sensor 55 for transmission to the surface. It is contemplated that the communication of measurement readings from sensor 55 to transponder 60 can be carried out in various ways. According to a simple approach, transponder 60 has an electrical input at which it continuously receives, directly from sensor 55, an analog signal representative of the measurement at the present time; in this case, acquisition process 66 is performed by transponder 60 simply by sampling the analog level at its sensor input. Alternatively, depending on the capability of transponder 60, acquisition process 66 can involve retrieving one or more previously sampled measurement readings (with or without some filtering applied) from its internal memory.

In any case, in process 68, transponder 60 transmits an acoustic response signal including the measurements acquired in process 66. According to the example described above, this transmitted response signal is in the form of a modulated acoustic carrier signal at a preselected carrier frequency, with the modulations including the measurement data encoded according to the transponder address code assigned to that particular transponder 60, distinguishing it from other transponders 60 in the vicinity. In process 70, that acoustic response signal is received by the acoustic transducer 51 at ROV 50 that issued the interrogation signal in process 62; in process 72, the transceiver electronics at ROV 50 operate to recover the measurement data from the modulated response signal, and communicate that measurement data in the appropriate manner to ship 48 via umbilical 49. Typically, more than one transponder 60 is within range of ROV 50 in its current position, such that the interrogation and response sequence repeats in sequence. If a next transponder 60 to be interrogated is not currently within the acoustic range of ROV 50 (decision 73 is “no”), surface ship 48 then navigates ROV 50 to a position within acoustic range of that next transponder 60 in process 74, in order to interrogate and receive a measurement from its associated sensor 55. In either that case, or if that next transponder 60 to be interrogated is in range (decision 73 is “yes”), the data acquisition and storage process of FIG. 4 then repeats.

Alternatively, measurement data can be acquired from transponders 60 without the use of ROV 50. For example, a wideband acoustic transponder such as the COMPATT 6 transponder, serving as the acoustic communications device, can be suspended directly from ship 48 by way of an umbilical including the appropriate wired communications facility. Modern transponders such as the COMPATT 6 transponder are contemplated to have sufficient acoustic range to carry out acoustic communication with one or more transponders 60 when deployed in that manner. In this alternative implementation, the suspended acoustic transponder will serve as the acoustic communications device by interrogating one or more transponders 60 by way of an address-bearing wideband interrogation signal, and receiving an encoded acoustic response signal from the addressed transponder 60 containing the measurement data in the manner described above for ROV-based data acquisition. The suspended acoustic transponder can communicate the measurement data to ship 48 during acquisition, for example by way of a wired communications facility in the umbilical. Alternatively, such a suspended acoustic transponder can store the measurement data it receives from transponders 60, for download to a computer system at ship 48 or elsewhere at the surface, after retrieval of the suspended transponder to the surface.

According to embodiments of this invention, the monitoring of important parameters such as pressure and temperature at a well following a blowout event can be obtained in a relatively frequent and real-time manner, despite loss of the normal communication medium between the well and the surface due to the blowout. Typically, the frequency of consecutive measurement data points will depend on the number of transponders 60 in the polling sequence carried out by ROV 50. These pressure and temperature measurements assist in attaining and maintaining control of the well in this event. The communications capability provided by embodiments of this invention can meet this critical need.

However, transponders 60 may not generally be deployed with blowout preventer 18 at the time of drilling, due to reliability considerations, for example. In addition, sensors that are originally implemented in blowout preventer 18 may not survive a blowout event, or may not be in position to sense the pressures and temperatures that are of particular importance for a well control strategy that becomes necessary in a specific situation. It is appreciated that the capping stack 45 will not be in place during drilling, and will only be implemented after the event. As such, post-blowout installation of sensors 55 and associated transponders 60 is contemplated to be necessary. Embodiments of this invention are directed to the construction and post-blowout installation of sensors 55 and transponders 60, as will now be described.

Flanged Sensor

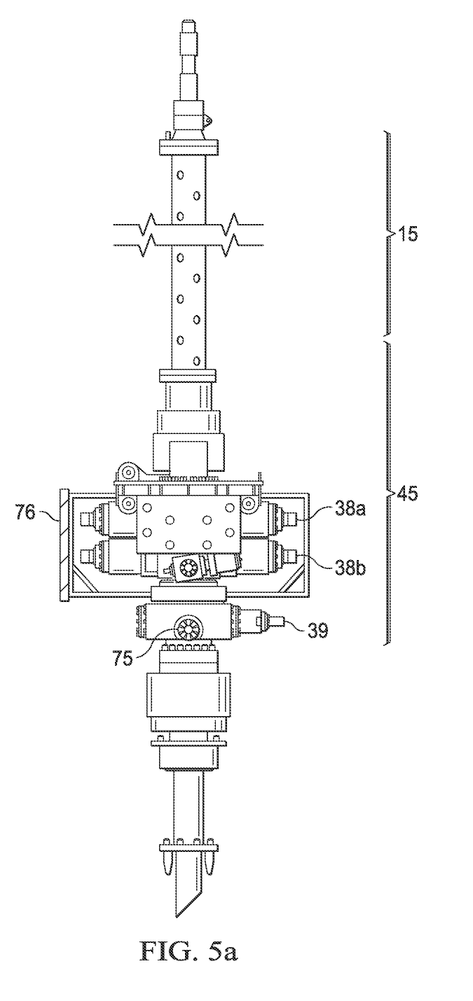

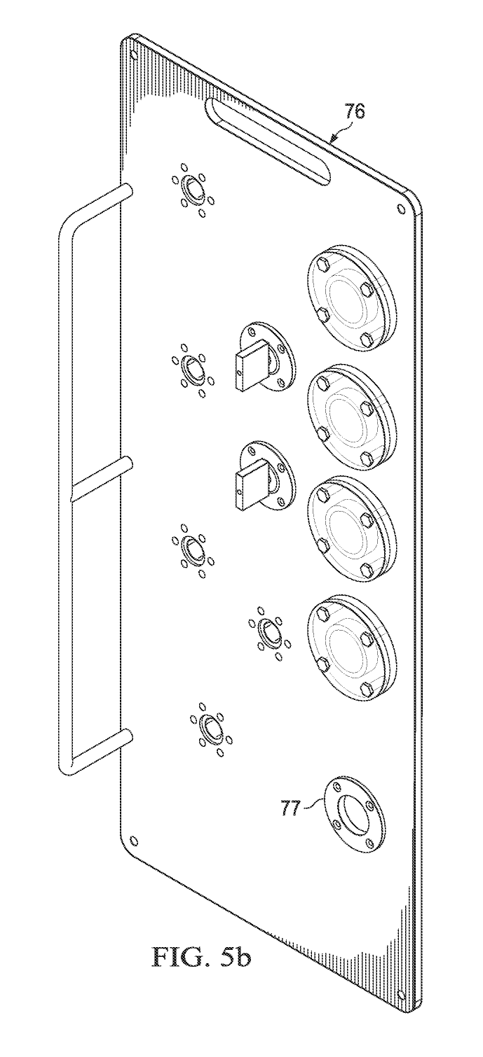

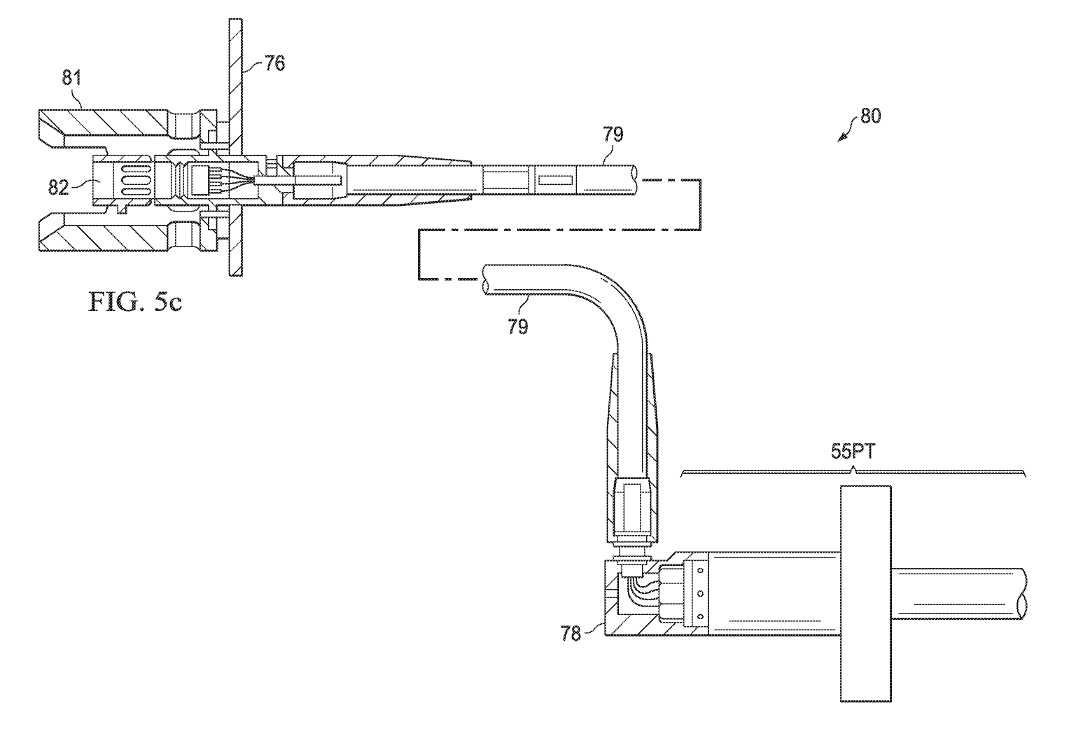

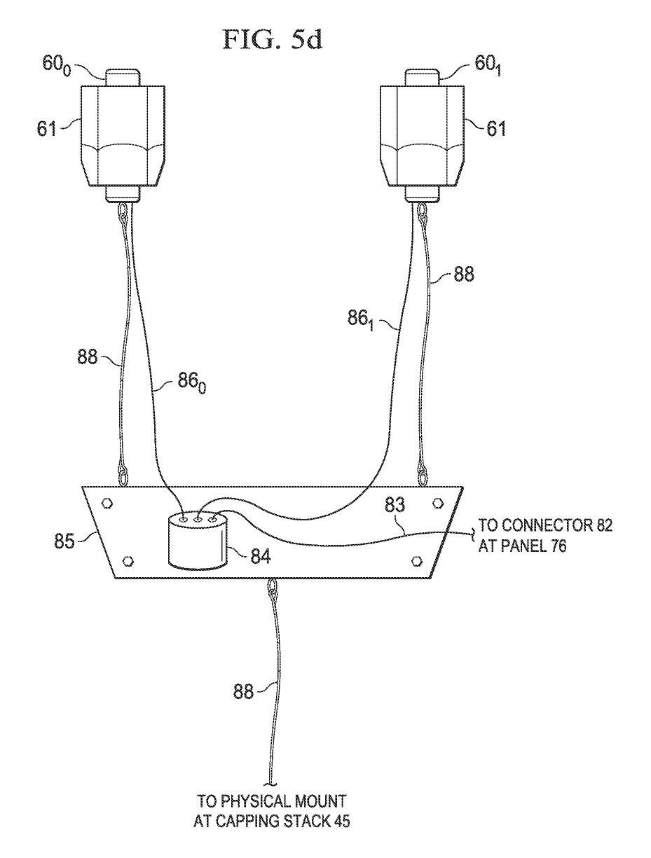

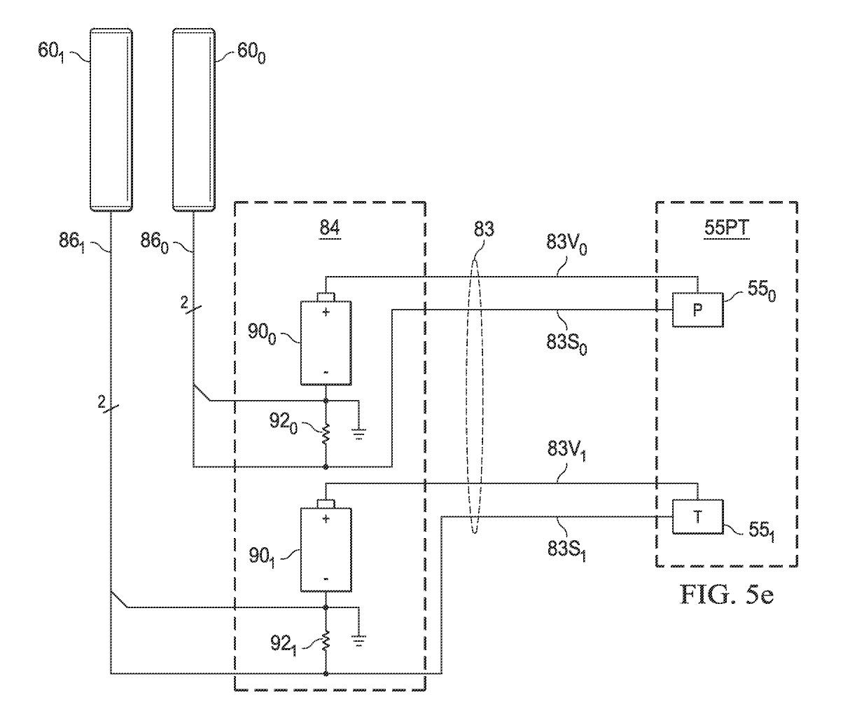

Referring now to FIGS. 5a through 5e, an embodiment of the invention in which either or both of pressure or temperature sensors 55 can be flanged into a sealing element assembly, such as blowout preventer 18 or capping stack 45, will now be described. The availability of such a flanged sensor installation depends on the construction of its destination at blowout preventer 18 or capping stack 45, particularly the presence of a flange in the assembly at a location that is relevant to the well control operation. The description of this embodiment of the invention will refer to installation at capping stack 45 by way of example, it being understood that installation at blowout preventer 18 will be effected in a similar manner.

FIG. 5a is an elevation view of an exemplary capping stack 45, as connected to riser 15. In this example, capping stack 45 includes upper and lower blind shear rams 38a, 38b, respectively, and single test ram 39. In this example, flange 75 is present at test ram 39, and is in fluid communication with the wellbore below test ram 39, and at which pressure, temperature, and other parameters that may be measured will be relevant to the control of the well following a blowout event. In an example of the implementation of this embodiment of the invention, one or more sensors 55 will be installed post-blowout at this flange 75, for acoustic communication of measurements to the surface in the manner described above in connection with FIG. 4.

FIG. 5a also illustrates the location of instrumentation and control panel 76 (along the left-hand side of capping stack 45 in that view), that will be utilized in connection with this embodiment of the invention. For example, panel 76 may correspond to either the choke panel or kill panel at capping stack 45, by way of which an ROV 50 can open or close various valves at rams 38a, 38b to carry out the desired choke or kill operation. FIG. 5b provides a perspective view of this panel 76, in which various valves and hydraulic connections are visible. In this example, opening 77 is a location in panel 76 at which may be installed a wet mate connector to sensors 55 mounted at flange 75, as will be described below.

FIG. 5c illustrates, in cross-section, sensor assembly 80 used in connection with this embodiment of the invention. Sensor assembly 80 includes pressure/temperature sensor 55PT. An example of pressure/temperature sensor 55PT useful in connection with this embodiment of the invention is a Cormon 11 kpsi dual-pressure and single-temperature transmitter, with a 4-20 mA output, available from Teledyne Cormon Limited. Sensor 55PT is installed into location 75 (FIG. 5a) of capping stack 45 in the conventional manner, utilizing an adapter flange as necessary for mounting at that location; that adapter flange and the mounting of sensor 55PT thereto, should be assembled and pressure tested prior to use. Electrical connection to sensor 55PT, including both power and signal lines, is made via connection shell 78, at which twisted pair wires within conduit hose 79 can be connected in the conventional manner. Conduit hose 79 runs from flange location 75 (FIG. 5a) at which sensor 55PT is mounted around to panel 76 on the side of capping stack 45. Conduit hose 79 connects to and terminates at wet mate connector 82 that is mounted at opening 77 of panel 76, and enables electrical connection to sensor 55PT via conduit hose 79. An example of wet mate connector 82 suitable for use in connection with this embodiment of the invention is one of the NAUTILUS wet-mateable electrical connectors available from Teledyne ODI (Ocean Design, Inc.). Alignment funnel guide 81 surrounds connector 82, to assist the ROV in making electrical connection to connector 82.

FIG. 5d illustrates the physical arrangement of the communications transmitter function associated with sensor 55PT. Electrical conduit 83 extends from battery can 84 mounted to panel 85, as shown in FIG. 5d, to make connection to wet mate connector 82 at panel 76 (FIG. 5c). Panel 85 is a support panel formed of the appropriate steel or aluminum material, and is physically attached or mounted to capping stack 45 at an appropriate location by tether 88 and a corresponding connecting hook, or alternatively by bolts or another mechanical attachment. Panel 85 is physically attached to one or more acoustic transponders 60₀, 60₁ by way of corresponding tethers 88. In this example, because sensor 55PT provides both pressure and temperature measurements, respective acoustic transponders 60₀, 60₁ can separately communicate the pressure and temperature measurements obtained by sensor 55PT, over separate acoustic communications channels (which, accordingly, may be individually interrogated by acoustic transducer 51 on ROV 50). Alternatively, the communicated measurements may correspond to other measurements, for example two separate pressure measurements in this example in which sensor 55PT is a dual-pressure/single-temperature sensor. As suggested by FIG. 5d, each of acoustic transponders 60₀, 60₁ are disposed within floatation collar 61, such that transponders 60₀, 60₁ will be suspended above panel 85 to the extent permitted by tethers 88. Electrical connection between battery can 84 and acoustic transponders 60₀, 60ₖ, is made by electrical conduits 86₀, 86ₖ, respectively.

FIG. 5e illustrates the electrical arrangement of sensor 55PT and its associated acoustic transponders 60₀, 60ₖ. In the schematic of FIG. 5e, sensor 55PT includes separate pressure sensor 55₀ and temperature sensor 55₁, each of which output a current within a given range (e.g., 4 to 20 mA) corresponding to the sensed parameter. Battery can 84 includes separate batteries 90₀, 90₁ for powering sensors 55₀, 55₁, respectively, and resistors 92₀, 92₁ for converting the sensor current from its respective sensor 55₀, 55₁ to a voltage for communication to acoustic transponders 60₀, 60ₖ. Electrical conduit 83 from battery can 84 includes power lines 83V₀, 83V₁, which connect the anode of each battery 90₀, 90₁ to its respective sensor 55₀, 55₁. Conduit 83 also includes pressure signal line 83S₀, which carries the current output from sensor 55₀, and temperature signal line 83S₁, which carries the current output from sensor 55₁. Pressure signal line 83S₀ is connected to the cathode of battery 90₀ (at ground) via resistor 92₀, and temperature signal line 83S₁ is connected to the cathode of battery 90₁ (at ground) via resistor 92ₖ, in each case completing the circuit. In this example, transmitters 55₀, 55₁ each function as variable current sources, with the output current dependent on the measured pressure and temperature, respectively.

Resistors 92₀, 92ₖ, in this example, are nominal 250Ω resistors, for converting the sensor output current range of 4 to 20 mA to the acoustic transponder input voltage range of 1 to 5 volts, maximizing the resolution of the communicated results. As such, conduit 86₀ includes two wires connected across resistor 92₀ within battery can 84, communicating the voltage drop across resistor 92₀ to transponder 60₀; conduit 86₁ similarly includes two wires connected across resistor 92₁ in battery can 84, communicating the voltage drop across 92₁ to transponder 60ₖ. Transponders 60₀, 60₁ each include their own battery, and thus do not require power from battery can 84. Considering that transponders 60₀, 60₁ sense input voltage, these devices present a very high input impedance to the sensor circuits.

Because absolute temperature and pressure readings from blowout preventer 18 or capping stack 45, as the case may be, are desirable in attaining and maintaining well control, it is of course important to precisely know the resistances of each of resistors 92ₒ, 92₁. It has been observed, in connection with this invention, that the specified precision of conventional precision resistors is not necessarily adequate for this purpose. According to this embodiment of the invention, post-installation calibration of these resistors can be carried out based on the calibration data of the sensors obtained at the time of manufacture. According to this approach, for the example of pressure sensor 55₀, independent knowledge of the ambient pressure can be obtained, for example by obtaining a measurement from ROV 50 or by calculation. A pressure measurement from sensor 55₀ is then obtained under those same ambient conditions, by way of interrogation by ROV 50 in the manner described above. The signal received from associated acoustic transponder 60₀ will, of course, correspond to the voltage across resistor 92₀ for that measurement. Using the manufacturer calibration data to estimate the current at the known ambient pressure, the communicated voltage communicated by transponder 60₀ can be divided by that estimated current to precisely determine the resistance value of resistor 92₀. Once that precise resistance value is determined, the measured voltages communicated by transponder 60₀ can be divided by that resistance value to obtain the output current from sensor 55₀, and thus an accurate measurement of pressure, upon scaling the measured output current within its full output current range (e.g., between 4 mA to 20 mA), which corresponds to the minimum and maximum pressures indicated by the calibration data at those full current range endpoints. It has been observed, in practice, that this calibration approach provides good accuracy in the measurements obtained from sensors 55₀, 55₁, and thus provides a way to calibrate these important measurements post-installation.

This embodiment of the invention thus enables post-blowout installation and operation of the necessary equipment and resources after a blowout event to communicate relatively frequent and real-time measurements of important parameters, such as pressure, temperature, and the like, based upon which well control actions can be determined and evaluated.

Hot Stab Sensor

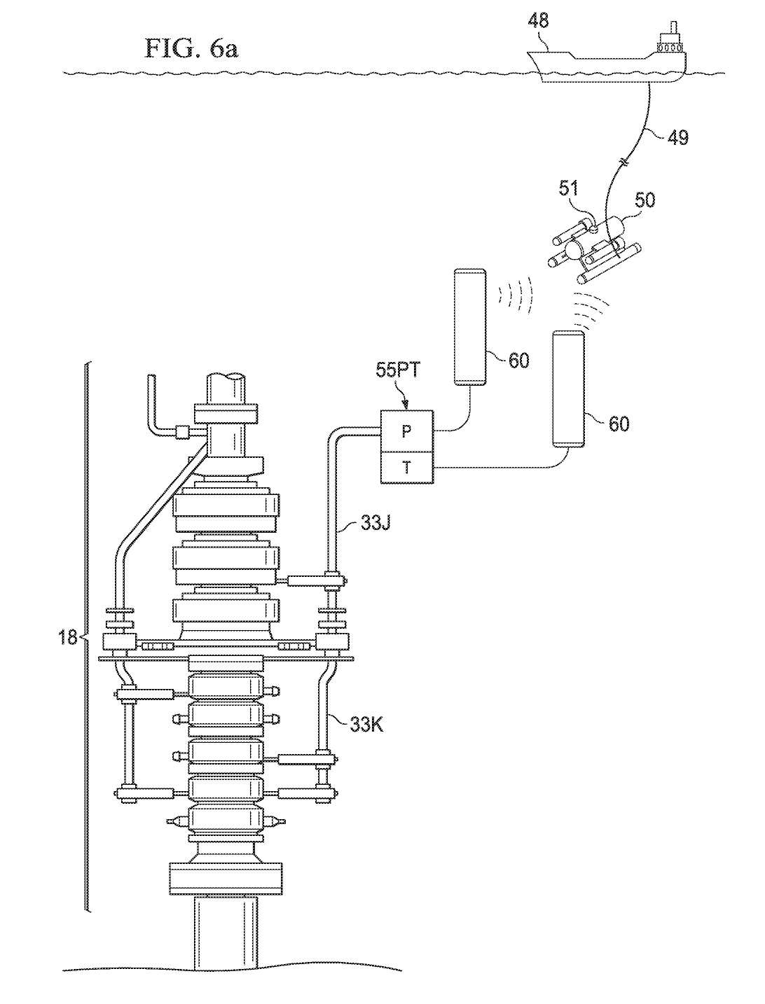

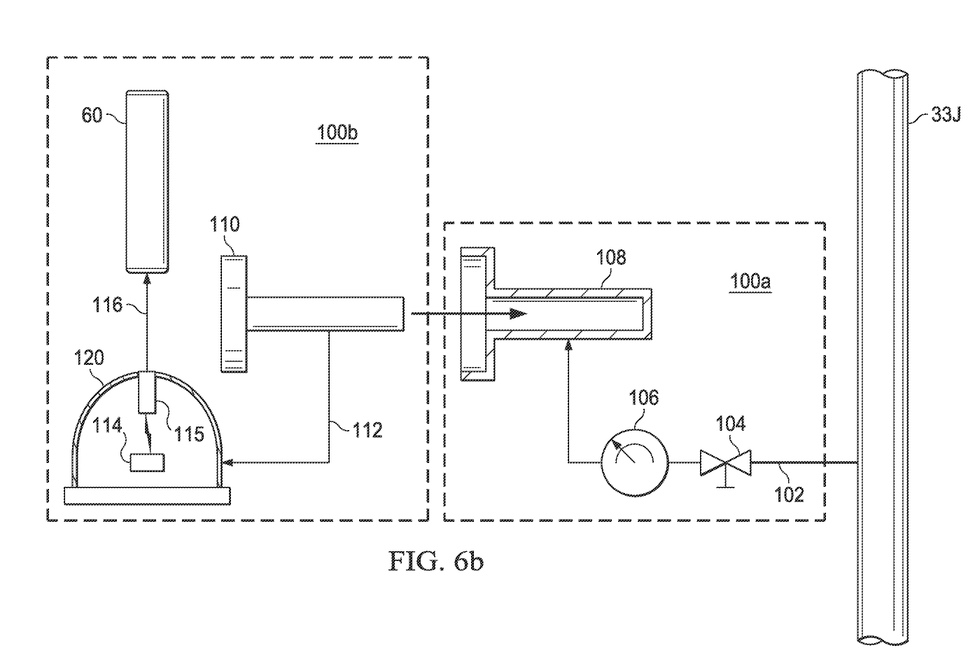

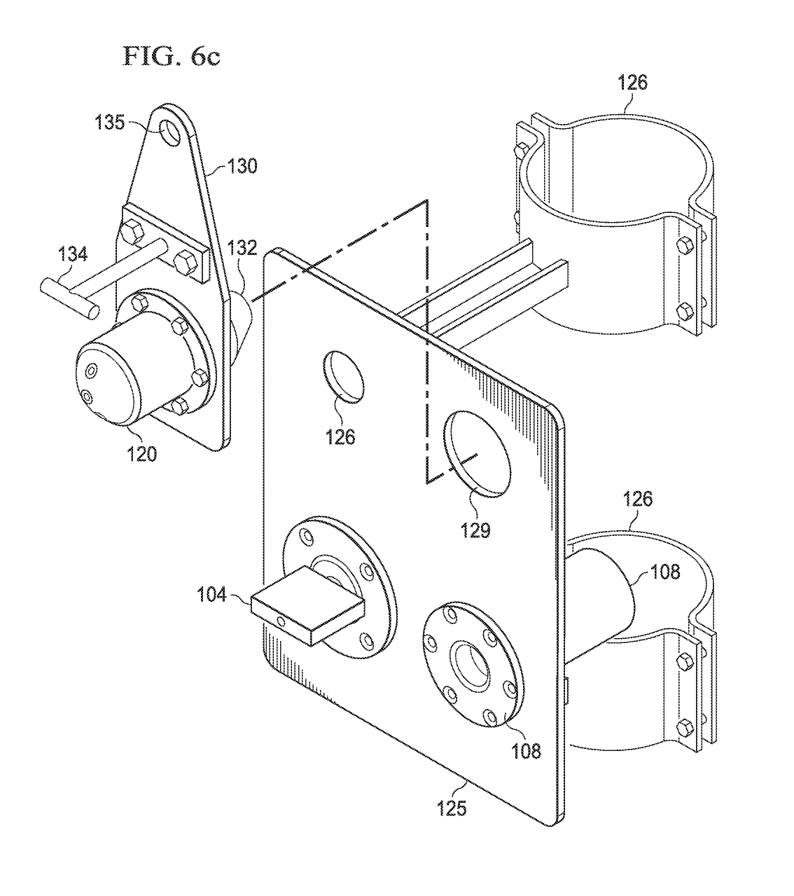

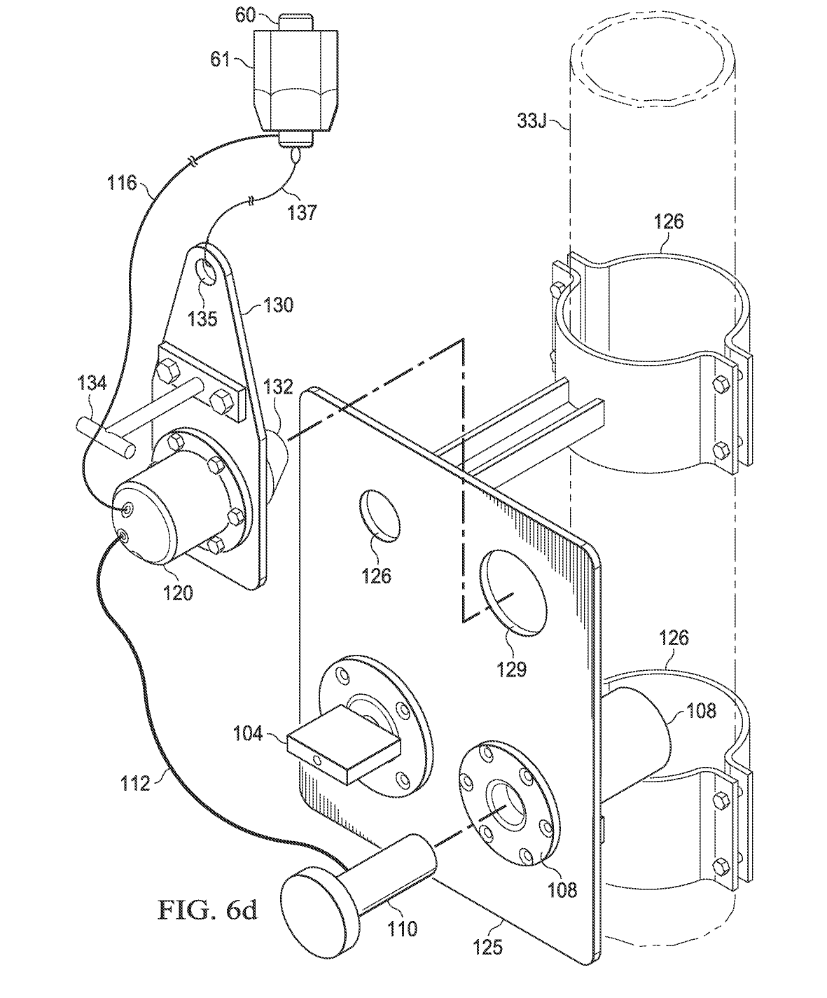

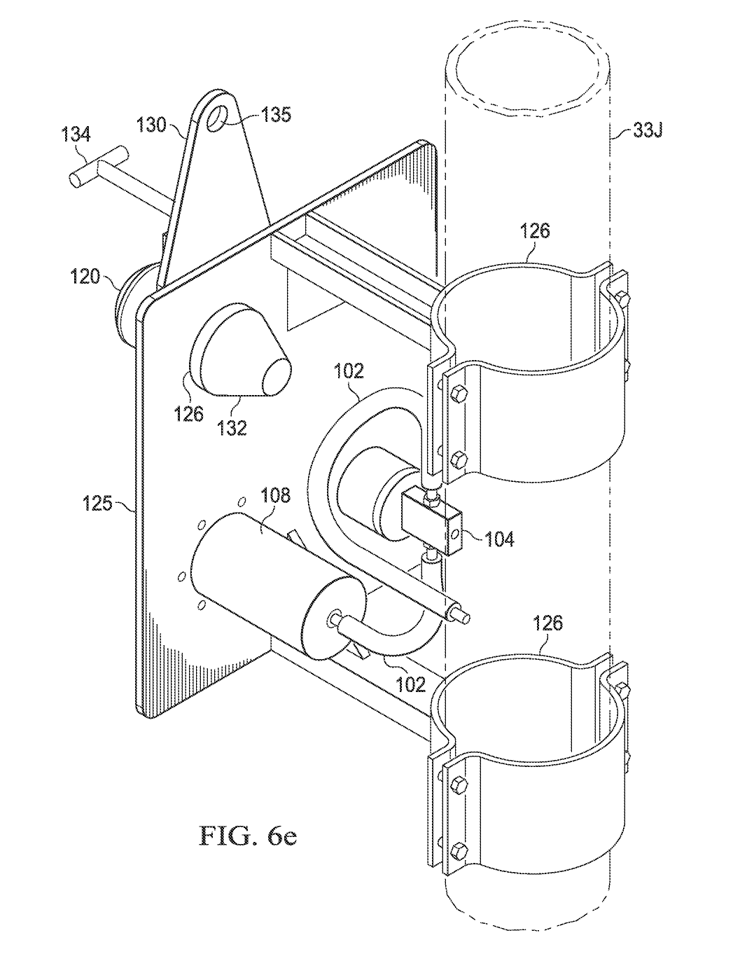

According to another embodiment of the invention, as will now be described in connection with FIGS. 6a through 6e, one or more sensors 55 are installed post-blowout into a jumper line or other conduit, by way of a hot stab arrangement. As discussed above, one or both of choke line 33C and kill line 33K can be re-routed by way of a jumper conduit to conduct kill fluid from the well annulus in a well control operation, or to conduct drilling mud from the surface to control the well, or for some other function involved in controlling the well. In each of those instances, parameters regarding the contents of the jumper conduit or other piping at the sealing element assembly (e.g., blowout preventer 18, capping stack 45) may be of interest to the well control operations. This embodiment of the invention enables the installation and operation of a communications system by way of which frequent and real-time measurements from those sensors are communicated to the surface, despite the absence of a fixed communications medium such as a wired facility along the drill string or production tubing.

FIG. 6a illustrates this arrangement in a generalized form. As shown in that Figure, kill line 33K of blowout preventer 18 has been severed from riser 15, and re-routed via jumper conduit 33J to a source of drilling mud at the surface, or to a downhole collection and disposal manifold, or to some other source or destination of the fluid conducted via jumper conduit 33J and kill line 33K, depending on the particular well control operation. In any case, parameters such as pressure and temperature at the interior of jumper conduit 33J are of interest to the well control operations. According to this embodiment of the invention, sensors 55PT are connected to be in fluid communication with jumper conduit 33J on one side, and in electrical connection with acoustic transponder 60 on another side/end. As described above, acoustic transponder 60 communicates acoustic signals encoded with data corresponding to the pressure or temperature measurements acquired by sensors 55PT, upon receipt of an interrogation signal from an acoustic communications device, such as acoustic transducer 51 mounted on ROV 50 in combination with its transceiver electronics, as described above. In that example, acoustic transducer 51 receives the encoded response signal from acoustic transponder 60, and its associated transceiver electronics then communicate data corresponding to the acquired measurements via umbilical 49 to computing and monitoring systems at ship 48.

FIG. 6b shows a hydraulic and electrical schematic of the sensor and communications system according to this embodiment of the invention. As will be apparent to those skilled in the art, the connection of kill line 33K or choke line 33C to some other source or destination in response to a blowout event requires the installation of the appropriate jumper conduit and other equipment, in connection with the well control procedure. According to this embodiment of the invention, a portion of the sensor and communications system is installed initially with this jumpering onshore, prior to deployment of the combination of jumper conduit 33J; sensors 55PT and acoustic transponder 60 are subsequently installed by way of an ROV at the appropriate time.

In this embodiment of the invention, system portion 100a is installed onto jumper conduit 33J prior to deployment. System portion 100a includes instrumentation tubing 102, which is in fluid communication with the vessel or tubing to be monitored, which in this case is jumper conduit 33J. Paddle valve 104 is in-line with instrumentation tubing, with dial gauge 106 optionally plumbed into instrumentation tubing 102 beyond paddle valve 104. Instrumentation tubing 102 terminates at hot stab receptacle 108, which is mounted to an appropriate gauge panel 125, which is shown in FIG. 6c as will now be described. Gauge panel 125 includes clamps 126 that clamp to jumper conduit 33J, securely mounting panel 125 and its associated components to the subsea equipment. FIG. 6c also illustrates paddle valve 104 and hot stab receptacle 108 at gauge panel 125; instrumentation tubing 102 is not shown, for purposes of clarity. Window 126 provides ROV visibility of dial gauge 106, which may be installed, if desired, behind panel 125 (i.e., on the same side of panel 125 as clamps 126).

Referring back to FIG. 6b, system portion 100b is installed subsea, after deployment of jumper conduit 33J and system portion 100a, as described above. According to this embodiment of the invention, system portion 100b includes hot stab connector 110, which is constructed to mate with hot stab receptacle 108. Conduit 112 is in hydraulic communication with hot stab connector 110, and hydraulically connects hot stab connector 110 to housing 120, within which sensor 115 and battery 114 (serving as the power source for sensor 115) are housed. Electrical conduit 116 electrically connects sensor 115 with acoustic transponder 60. If level (or current-to-voltage) conversion is required to calibrate the output range of sensor 115 to the input range of acoustic transponder 60, the appropriate components will be implemented within housing 120, as described above.

FIG. 6c illustrates floatation attachment 130, to which housing 120 (and thus sensor 115 and its battery 114) is mounted. Floatation attachment 130 is a small panel to which housing 120 is mounted opposite lead cone 132; ROV handle 134 is mounted to the housing side of floatation attachment 130. Lead cone 132 facilitates mounting of floatation attachment 130 by an ROV in the subsea environment, by way of the insertion of lead cone 132 into opening 129 of panel 125.

FIGS. 6d and 6e schematically illustrate the fluid and electrical connection among the various components of system portions 100a, 100b. As shown in FIGS. 6d and 6e, clamps 126 affix panel 125 to jumper conduit 33J. As shown in FIG. 6e, hydraulic conduit 102 is plumbed to jumper conduit 33J behind panel 125, and is routed through paddle valve 104 to hot stab receptacle, for this example in which dial gauge 106 is not present. Referring back to FIG. 6d, hot stab connector 110 is connected via hydraulic conduit 112 to a receptacle at housing 120 (FIG. 6e). Upon insertion of hot stab connector 110 into hot stab receptacle 108, housing 120 will be in fluid communication with hydraulic conduit 102, as mentioned above.

As shown in FIG. 6d, acoustic transponder 60 is deployed within floatation collar 61, and is physically attached to opening 135 of floatation attachment 130 by way of tether 137. Electrical conduit 116 is connected between a receptacle at housing 120, and acoustic transponder 60; conduit 116 is somewhat longer than tether 137, to avoid the tension from floatation collar 61. As shown in FIG. 6e, lead cone 132 is insertable into opening 126 of panel 125, but is smaller than opening 126. The upward force exerted by floatation collar 61 and tether 137 will pull lead cone 132 upward, locking it into opening 126 and thus securing floatation attachment 130 to panel 125.

The communication of measurements obtained by sensor 115 (within housing 120) according to this embodiment of the invention is similar to that described above for the flanged installation. Accordingly, upon insertion and mating of hot stab connector 110 into and with hot stab receptacle 108, the interior of housing 120 is in fluid communication with jumper conduit 33J, via hydraulic conduit 102, 112, and paddle valve 104. Sensor 115 is thus able to sense the particular parameter (e.g., pressure) of that fluid, and thus the fluid of jumper conduit 33J as desired. It is contemplated that this hot stab sensor installation will generally be better suited for sensing and communicating pressures rather than temperatures. Sensor 115 issues an electrical signal (e.g., a voltage within a specified range) to acoustic transponder 60 corresponding to the sensed pressure, temperature, or other parameter. Upon receipt of an acoustic interrogation signal from an acoustic communications device, such as acoustic transducer 51 on ROV 50, as described above, acoustic transponder 60 transmits an acoustic signal encoded with data corresponding to the measurement obtained by sensor 115. In that example, acoustic transducer 51 and its associated transceiver electronics at ROV 50 then communicate data corresponding to this and other measurements acquired from other sensors, to surface personnel via umbilical 49 and ship 48, in the manner described above.

According to this embodiment of the invention, post-blowout installation and operation of the necessary equipment and resources to monitor and frequently communicate real-time measurements of important parameters relevant to well control operations can be carried out.

Network Redundancy

In the event of a compromised component, device, or system of an offshore oil and gas well, a large number of personnel may be involved in taking remedial action. Time may be of the essence in making decisions regarding well control actions to be taken, and the importance of those decisions requires evaluation of the best available subsea measurement data. Reliability in the acquisition and communication of those subsea measurement data at a relatively high frequency and continuously over time is therefore an important attribute of the overall measurement communication system.

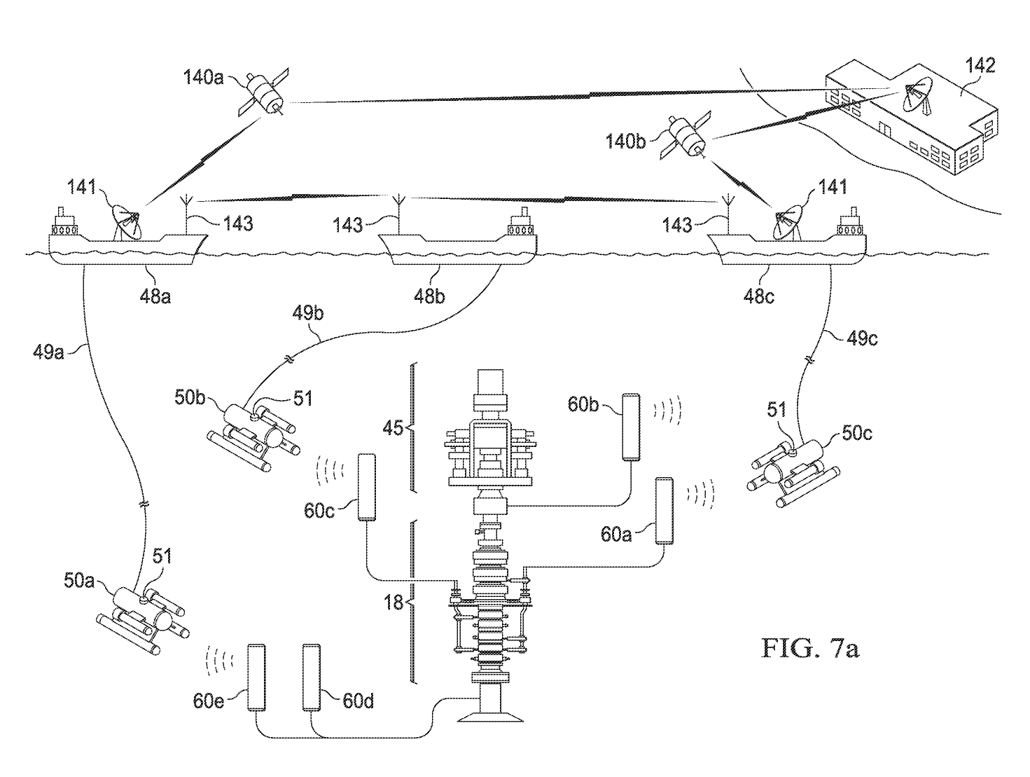

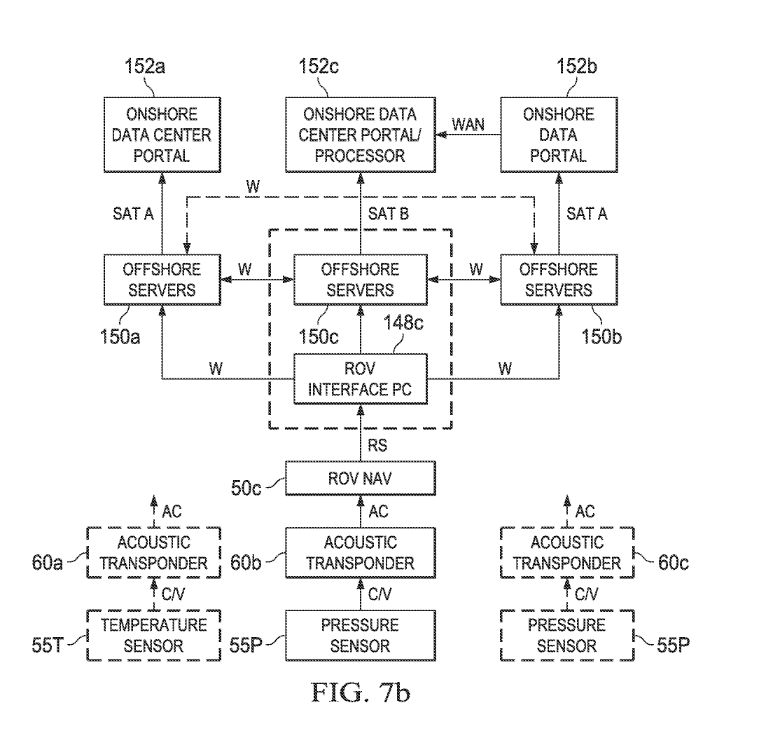

According to embodiments of this invention, a high level of communications network redundancy can be implemented, as will now be described in connection with FIGS. 7a and 7b. FIG. 7a illustrates an example of the installation of several sensor and transponder packages at blowout preventer 18 and capping stack 45; the various sensors are not shown in FIG. 7a, given the scale of the view. In this example, a hot stab pressure sensor (i.e., according to the embodiment of FIGS. 6a through 6e) is installed at the re-routed and jumpered choke line of blowout preventer 18 and connected to acoustic transponder 60a; a flanged pressure sensor (i.e., according to the embodiment of FIGS. 5a through 5e) is installed at capping stack 45 and connected to acoustic transponder 60b; a hot stab pressure sensor is installed at the re-routed and jumpered kill line of blowout preventer 18 and connected to acoustic transponder 60c; and a flanged pressure and temperature sensor is installed at blowout preventer 18 and connected to acoustic transponders 60d, 60e for communicating pressure and temperature measurements, respectively. Of course, more or fewer sensors and acoustic transponders may be present in a particular installation.

As shown in FIG. 7a, multiple ROVs 50a through 50c are in the vicinity of blowout preventer 18 and capping stack 45, each having an acoustic communications device (i.e., acoustic transducer 51 and associated transceiver electronics) interrogating each of acoustic transponders 60 and receiving measurement data in response. ROVs 50a through 50c are supported from associated surface ships 48a through 48c, respectively; of course, a given ship 48 may support more than one ROV 50, if desired. Each ship 48 has its own computer network on board, by way of which measurement data acquired from subsea sensors at blowout preventer 18 and capping stack 45 can be monitored and analyzed. In addition, according to the redundancy implemented in this embodiment of the invention, each ship 48 includes multiple communication facilities for communicating those data. In this example, ships 48a, 48c include satellite communications capability, indicated by satellite “dish” 141 in FIG. 7a, and also wireless radio communications capability, indicated by its radio antenna 143. Ship 48b in this example includes only wireless radio communications capability. In this embodiment of the invention, wireless radio communications are used in a “local” area network made up of the computer networks among ships 48a through 48c at sea and in the vicinity of the well. Satellite communications are used in connection with that “local” area network as well, and also for communication with one or more data centers 142 located onshore, or around the world as the case may be. Alternatively, ships such as ship 48b that do not have satellite capability may be used simply as repeaters in the network arrangement.

In operation, the acoustic communications device at each ROV 50 operates essentially autonomously from those at the other ROVs 50 in interrogating acoustic transponders 60. For example, acoustic transducer 51 of ROV 50c may be interrogating acoustic transponder 60a, at the same time that respective acoustic transducers 51 of ROVs 50a, 50b are interrogating acoustic transponders 60e, 60c, respectively. As described above, in response to an acoustic interrogation signal from an acoustic transducer 51, for example addressed to a particular acoustic transponder 60, that acoustic transponder 60 will acoustically transmit a modulated signal containing a measurement obtained by its corresponding sensor 55 (FIG. 3). Following an interrogation/response cycle, an ROV 50 may remain in place, and interrogate another acoustic transponder 60 that is within range at that same location. For example, ROV 50c may remain in its current location and with its acoustic transducer 51 interrogating acoustic transponder 60b after receiving the response from acoustic transponder 60a. It is contemplated that tethers 88, 137 attaching transponders 60 to their mounted locations may be sufficiently long to allow transponders 60 to float above capping stack 45, facilitating the polling of multiple transponders 60 by an ROV 50 at a single location. If necessary, a given ROV 50 may be required to travel to a location near another acoustic transponder 60 to receive a next measurement; for example, ROV 50b may travel from its location at acoustic transponder 60c to a location near acoustic transponder 60b, in order to obtain another measurement. In addition, data centers 142 (or other surface personnel) receiving measurement data from sensors 55 may include the appropriate onboard computer system that indicates the frequency with which those measurement data are being obtained. For example, the appropriate display may include an indication of the “health” of the data acquisition system. In this regard, it is contemplated that a visible indicator on the monitoring display may provide such indication by way of a “traffic light” display (e.g., a green display indicating nominal operation, a yellow display indicating loss of measurement data for a short time such as five minutes, and a red display indicating loss of measurement data beyond a longer threshold such as one hour). In the event of a significant time period without measurement data, surface personnel may initiate an appropriate corrective action, for example directing an ROV 50 to reposition itself to better obtain measurement data from one or more transponders 60, or dispatching a new ROV 50 if necessary. In any event, it is contemplated that multiple ROVs 50 can cooperate in obtaining measurement data from around blowout preventer 18 and capping stack 45 at such frequency as desired by surface personnel.

FIG. 7b illustrates the logical network arrangement implemented by this embodiment of the invention, as applicable for the example of FIG. 7a, illustrating the communication path of measurement data from one subsea pressure sensor 55P. As evident from FIG. 7b, other sensors 55T, 55P are simultaneously in place, and will similarly communicate their measurement data via the same network, upon interrogation as described above. The data flow of FIG. 7b begins with a pressure measurement from pressure sensor 55P at blowout preventer 18, capping stack 45, or some other subsea transducer, as described above. That measurement signal is communicated as a current or voltage (C/V) to an associated acoustic transponder 60b, as described above. Upon conversion to digital and the appropriate formatting and modulation, acoustic transponder 60c acoustically transmits (AC) that measurement to acoustic transducer 51 and its corresponding transceiver electronics (e.g., modem) at ROV 50c, in response to an acoustic interrogation issued from that acoustic transducer 51 at ROV 50c. The measurement data received by the acoustic modem (e.g., ROVNAV) at ROV 50c is communicated, for example by way of a serial connection (RS) within umbilical 49c, to ROV interface PC 148 at its associated ship 48c, in a conventional manner.

Measurement data obtained by an instance of ROV interface PC 148c at ship 48c is then communicated and distributed in a highly redundant networked fashion, according to embodiments of this invention. In this example, ROV interface PC 148c is connected to offshore servers on its ship 48c by a conventional wired or wireless LAN connection, or by way of a local connection via a client terminal. For example, one conventional ROV positioning system is realized according to the infrastructure and system available from Fugro NV, in which ROV interface PC 148c includes a receiving device connected into the appropriate network switch and LAN resident on ship 48c. In addition, ROV interface PC 148c aboard ship 48c can include unlicensed or licensed broadband wireless data radio communications capability among ships 48c and its neighboring ships 48a, 48b, for example in a ring network utilizing transceiver functions and infrastructure available from FreeWave Technologies, Inc. As mentioned above, if a particular ship 48 does not have satellite capability, that ship 48 may be used to relay measurement data by this wireless radio facility to another ship 48 that has satellite capability. These wireless links (W) among the various offshore servers 150a through 150c are illustrated in FIG. 7b.

According to embodiments of this invention, it is contemplated that offshore servers 150 may vary in operation and structure among one another. For example, offshore servers 150c on ship 48c can be constructed and operational in a manner involving a universal file loader (UFL) operating according to the PI systems available from OSlsoft, LLC. Offshore servers 150a may correspond to the INSITE ANYWHERE network functionality and services available from Halliburton, such functionality including data acquisition and data integration; offshore servers 150b may simultaneously be realized according to another system infrastructure, such as the data acquisition and data integration functions operating according to the JOBMASTER monitoring software available from BJ Services. These and other conventional data acquisition, integration, and monitoring tools can be utilized to receive and process the measurement data acquired from subsea sensors 55 according to embodiments of this invention. In any event, the data integrator functions of each offshore server 150 can be placed in communication with the data acquisition functions of other offshore servers 150, with those data acquisition systems processing and formatting the received measurement data in a manner consistent with its own data integration function.

Also as shown in FIG. 7a, ships 48a and 48c support satellite communications capability with one another, if desired, and with onshore or other offshore facilities including one or more data center portals 152 (FIG. 7b). Redundant satellites 140a, 140b as suggested by FIG. 7a enables communications robustness to worldwide weather conditions, for example by communicating via links with data center portals 152 in different locations of the world (e.g., one in Newfoundland via satellite 140a, i.e., link SAT A of FIG. 7b, and another in the southern United States via satellite 140b, i.e., link SAT B of FIG. 7b), and may be constructed and operate independently from one another. For example, onshore data center portal 152a may correspond to an INSITE ANYWHERE system portal, to which processed and integrated measurement data from the INSITE ANYWHERE data integration function at offshore servers 150a can be communicated. Similarly, onshore data center portal 152b can correspond to a BJ Services JOBMASTER data portal, consistent with the JOBMASTER data integration function of offshore servers 150b. Onshore data center portal/processor 152c may be realized as a UFL/PI PROCESSNET servers, as known in the art and as available from OSIsoft, consistent with the output from UFL/PI servers 150c in this example. In addition, intermediate or output data may also be communicated, by way of a wide-area-network communications link, from onshore data portal 152b to onshore data center portal/processor 152c, as suggested by FIG. 7b. Of course, the particular systems, functions, servers, and communications links involved in the networking of these various data paths can vary from that shown in FIG. 7b and described herein. For example, another oil and gas facility may be used in a manner similar to one of ships 48, for example as a repeater, via a data communications link carried by a fiber optic facility.

In any event, according to embodiments of this invention, substantial redundancy is provided in the communications network involved in obtaining and integrating measurement data from subsea sensors at the well following a blowout event, without requiring the riser, drill string, or other physical conduit to be in place. Measurement redundancy can be provided by including the capability of obtaining the desired measurements from multiple locations of the subsea equipment. For example, instances of both the flanged sensor and also the hot stab sensor may be implemented at a capping stack, providing backup sensor capability in the event of sensor failure or blockage (e.g., due to hydrate formation) at one installation. Subsea communications redundancy can be provided by deploying multiple ROVs 50, each with a corresponding acoustic transducer 51 and associated transceiver electronics, to simultaneously collect measurement data from sensors 55 via acoustic communications with acoustic transponders 60, as described above. These measurement data can be communicated in a highly redundant fashion according to embodiments of this invention, with each of the surface ships 48 having both wireless radio and satellite communications technology available. As such, if an issue arises regarding any one of the radio or satellite communications links, multiple alternative data paths in the overall network are provided according to embodiments of this invention, whether among the ships at the well site, or among onshore facilities such as data centers, or both. Geographical robustness of satellite communications is also incorporated, according to embodiments of this invention. The system according to this embodiment of the invention also does not rely on a single data acquisition and processing protocol, thus enabling multiple vendors to be involved at the well. The overall robustness of the system is therefore improved.

According to embodiments of this invention, sensors can be installed subsea, for example after an event such as blowout of a well, and their measurements obtained and communicated without the presence of a riser, drill string, or production tubing supporting the communications medium. In particular, sensors and corresponding acoustic transponders are installed at locations of a blowout preventer, capping stack, or other sealing element assembly, with the acoustic transponders capable of acoustically communicating the measurement data upon interrogation by a remotely-operated vehicle in the vicinity of the well. Upon receipt of the measurement data at a surface vessel, a redundant communications network is implemented by way of which data may be communicated among the vessels in the vicinity, and by satellite to onshore or other data centers, for monitoring and analysis. The continuous and real-time measurements acquired and analyzed in this manner facilitate the rapid and effective selection and evaluation of well control actions.

It is contemplated that embodiments of this invention can be utilized in alternative applications. For example, it is contemplated that this invention can be readily applied, by those skilled in the art having reference to this specification, to subsea structures for which a communications medium is not already in place. For example, the sensors may correspond to corrosion detectors; implemented into subsea pipelines and their measurements acoustically communicated acquired at and communicated by ROVs, in the manner described herein. Further in the alternative, if fiber optics in an existing production umbilical fail, acoustic communications according to this invention can provide a workable remediation approach.

While the present invention has been described according to its embodiments, it is contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of communicating measurements from subsea equipment, comprising the steps of:
sensing one or more physical parameters at the subsea equipment;
communicating an electrical signal corresponding to a first sensed physical parameter to a first acoustic transponder at the subsea equipment;
operating the first acoustic transponder to transmit a coded acoustic signal including data corresponding to the first sensed physical parameter;
receiving the coded acoustic signal at an acoustic communications device within acoustic range of the first acoustic transponder; and
communicating data corresponding to the first sensed physical parameter from the acoustic communications device to a surface location.

2. The method of claim 1, further comprising:
operating the acoustic communications device to transmit an interrogation signal to the first acoustic transponder;
wherein the step of operating the first acoustic transponder to transmit the coded acoustic signal is performed responsive to the first acoustic transponder receiving the interrogation signal.

3. The method of claim 2, wherein the acoustic communications device is deployed at a first underwater vehicle;
and further comprising:
navigating the underwater vehicle to within acoustic range of the first acoustic transponder; and
after receipt of the coded acoustic signal including the stored measurement data by the acoustic communications device, communicating data corresponding to the stored measurement data from the underwater vehicle to the surface location.

4. The method of claim 3, further comprising:
communicating an electrical signal corresponding to a second sensed physical parameter to a second acoustic transponder at the subsea equipment;
after the step of receiving the coded acoustic signal from the first acoustic transponder, moving the first underwater vehicle to a location within acoustic range of the second acoustic transponder;
then operating the acoustic communications device deployed on the first underwater vehicle to transmit an interrogation signal to the second acoustic transponder;
responsive to the second acoustic transponder receiving the interrogation signal, operating the second acoustic transponder to transmit a coded acoustic signal including data corresponding to the second sensed physical parameter;
receiving the coded acoustic signal including data corresponding to the second sensed physical parameter at the acoustic communications device at the first underwater vehicle; and
communicating data corresponding to the second sensed physical parameter from the first underwater vehicle to a surface location.

5. The method of claim 3, further comprising:
operating an acoustic communications device at a second underwater vehicle to transmit an interrogation signal to the first acoustic transponder;
responsive to the first acoustic transponder receiving the interrogation signal from the second underwater vehicle, operating the first acoustic transponder to transmit a coded acoustic signal;
receiving the coded acoustic signal at the acoustic communications device at the second underwater vehicle near the subsea equipment; and
communicating data corresponding to the first sensed physical parameter from the second underwater vehicle to a surface location.

6. The method of claim 5, wherein the first underwater vehicle communicates data corresponding to the first sensed physical parameter to a first vessel at the surface;
and wherein the second underwater vehicle communicates data corresponding to the first sensed physical parameter to a second vessel at the surface.

7. The method of claim 6, further comprising:
communicating data corresponding to the first sensed physical parameter from the first vessel to a first server in a network via a radio communications link, and to a second server in the network via a satellite communications link; and
communicating data corresponding to the first sensed physical parameter from the second vessel to a third server in a network via a radio communications link, and to a fourth server in the network via a satellite communications link.

8. The method of claim 2, wherein the acoustic communications device is suspended from a surface ship by an umbilical;
and further comprising:
after receipt of the coded acoustic signal by the acoustic communications device, communicating data corresponding to the stored measurement data from the acoustic communications device to the surface location via a wired communications facility in the umbilical.

9. The method of claim 2, wherein the acoustic communications device is suspended from a surface vessel:
and further comprising:
after receipt of the coded acoustic signal including the stored measurement data by the acoustic communications device, retrieving the acoustic communications device to the surface;
then downloading the stored measurement data from the acoustic communications device to a computer system at the surface.

10. The method of claim 1, further comprising:
communicating an electrical signal corresponding to a second sensed physical parameter to the first acoustic transponder deployed at the subsea equipment;
wherein the operating step operates the first acoustic transponder so that the coded acoustic signal also includes data corresponding to the second sensed physical parameter;
and wherein the communicating step also communicates data corresponding to the second sensed physical parameter from the acoustic communications device to the surface location.

11. The method of claim 1, wherein the subsea equipment comprises a blowout preventer;
and wherein the first sensed physical parameter comprises a pressure at the blowout preventer.

12. The method of claim 11, wherein well tubing from the surface to the blowout preventer is severed;
and wherein the first sensed physical parameter comprises a pressure in a choke line at the blowout preventer.

13. The method of claim 11, wherein well tubing from the surface to the blowout preventer is severed;
and wherein the first sensed physical parameter comprises a pressure in a kill line at the blowout preventer.

14. The method of claim 11, wherein the subsea equipment comprises a capping stack mounted atop well tubing;
and wherein the first sensed physical parameter comprises a pressure at the capping stack.

15. A sensor and transponder system for installation at a sealing element assembly deployed at an offshore hydrocarbon well, comprising:
a sensor for sensing a physical parameter at a selected location of the sealing element assembly;
first electrical conduit connected to the sensor for coupling to a wet mate connector through an opening in a first panel attached to the sealing element assembly;
a second panel, for mounting to the sealing element assembly;
a battery can mounted to the second panel, having an interior, and having electrical receptacles at its exterior;
second electrical conduit coupled between a first electrical receptacle at the exterior of the battery can and the wet mate connector;
signal lines in the interior of the battery can connected between the sensor and a second electrical receptacle at the exterior of the battery can;
a battery disposed within the battery can, for powering the sensor through the wet mate connector and the first and second electrical conduit; and
a first acoustic transponder physically attached to the second panel, and electrically connected to the sensor via the second electrical receptacle at the battery can.

16. The sensor and transponder system of claim 15, further comprising:
a flange adapter for mounting the sensor to a flange at the sealing element assembly.

17. The sensor and transponder system of claim 15, wherein the sensor includes first and second transducers for sensing first and second physical parameters.

18. The sensor and transponder system of claim 15, further comprising:
signal lines in the interior of the battery can connected between the sensor and a third electrical receptacle at the exterior of the battery can; and
a second acoustic transponder physically attached to the second panel, and electrically connected to the sensor via the third electrical receptacle at the battery can;
wherein the signal lines connected to the second electrical receptacle are configured to communicate a first measurement signal to the first acoustic transponder;
and wherein the signal lines connected to the third electrical receptacle are configured to communicate a second measurement signal to the second acoustic transponder.

19. A sensor and transponder system for installation to a fluid line at a sealing element assembly deployed at an offshore hydrocarbon well, comprising:
a gauge panel having one or more clamps for attachment to the fluid line;
a hot stab receptacle at the gauge panel, configured to hydraulically couple to the fluid line;
a sensor housing having an interior;
a sensor disposed within the interior of the sensor housing;
a battery disposed within the interior of the sensor housing configured to power the sensor;
a fluid conduit, coupled between the interior of the sensor housing and a hot stab connector configured for coupling to the hot stab receptacle;
a floatation attachment, configured to couple to a receptacle at the gauge panel, the sensor housing mounted to the floatation attachment;
an acoustic transponder physically attached to the floatation attachment, and electrically connected to the pressure sensor at the sensor housing.

20. A method of calibrating pressure measurement data received from an acoustic transponder with absolute pressure measured at a sealing element assembly deployed at an offshore hydrocarbon well, comprising:
obtaining an ambient pressure value at the sealing element assembly;
sensing an ambient pressure at a pressure sensor installed at the sealing element assembly;
communicating an electrical current corresponding to the sensed ambient pressure from the pressure sensor to a resistor mounted near the pressure sensor;
operating an acoustic transponder to sense a voltage across the resistor, and to transmit a coded acoustic signal including data corresponding to the sensed voltage;
receiving the coded acoustic signal at an acoustic communications device near the subsea equipment;
communicating data corresponding to the sensed voltage from the acoustic communications device to a surface location;
estimating a sensor current from the obtained ambient pressure value using predetermined calibration data for the pressure sensor; and
from the communicated data, dividing the sensed voltage by the estimated sensor current to determine a resistance value of the resistor.

21. The method of claim 20, further comprising:
receiving additional coded acoustic signals from the acoustic transponder including data corresponding to a plurality of sensed voltages over time;
communicating data corresponding to the sensed voltages;
dividing each of the sensed voltages by the determined resistance value to obtain sensed currents; and
scaling the sensed currents to obtain measured pressure values over time at the sealing element assembly.
